(19) United States
(12) Patent Application Publication
(10) Pub. No.: US 2024/0428248 A1
(43) Pub. Date: Dec. 26, 2024

(54) Method and System for Verifying Restricted Purchases

(71) Applicants: Crystal Walker, Arlington, TX (US); Tyrone Walker, Arlington, TX (US); Anthony Walker, Belleville, IL (US)

(72) Inventors: Crystal Walker, Arlington, TX (US); Tyrone Walker, Arlington, TX (US); Anthony Walker, Belleville, IL (US)

(21) Appl. No.: 18/824,637

(22) Filed: Sep. 4, 2024

Related U.S. Application Data
(63) Continuation-in-part of application No. 17/898,129, filed on Aug. 29, 2022, now abandoned.

(51) Int. Cl. G06Q 20/40; G06Q 20/20

(52) U.S. Cl. CPC G06Q 20/40145; G06Q 20/206

(57) ABSTRACT

A system and method are provided for electronically verifying age-restricted purchases using biometric data and digital communication. The method comprises: receiving an application from a website via an electronic device; creating a customer account linked to the customer; and gathering biometric information—such as facial structures and thumbprints—using the customer's communication device. An approved customer receives a token. During a purchase, the customer scans an age-restricted product, and the store device prompts for self-age verification. The customer's biometric data is used to access the web application in purchase mode. The store device provides a transaction token barcode/QR code, scanned by the customer, which combines with the customer token to form a request token. This request token is sent to a centralized server for processing. Upon approval, an approval token is received by the store device, authorizing the age-restricted purchase.

### FIELD OF THE INVENTION

The present invention generally relates to the field of secure transaction systems and methods. More specifically focusing on enhancing the verification process for age-restricted purchases and access control. The present invention leverages biometric technologies to accurately and efficiently verify the identity and age of individuals, thereby facilitating secure and streamlined processing in retail and other environments requiring age verification.

### BACKGROUND OF THE INVENTION

In recent developments, age verification technology is increasingly incorporating biometrics to enhance security and efficiency in retail settings. Biometrics, including facial analysis and other biometric identifiers, are being used both online and in-person to control access to age-restricted goods.

In the United States and globally, policies are evolving to accommodate biometric age estimation in retail environments, such as grocery stores and sports venues, potentially reducing the need for manual age verification by store employees.

The integration of biometric age verification is becoming increasingly important as retail environments move towards more digitized and automated point-of-sale processes. This shift aims to streamline the purchasing process while maintaining compliance with age-restricted sales regulations.

One major issue is the efficiency and speed of the process. The manual method of age verification by store staff can cause delays and inefficiencies at checkout lines, particularly during peak shopping hours, which can negatively impact the overall customer experience. In addition, relying solely on visual identification by employees can lead to concerns about accuracy and security. Human error is a possibility, and fraudulent activities, such as the use of fake IDs, are not always easy to detect.

Moreover, there is a pressing need for integration with technology. As more consumers turn to digital wallets and mobile devices, retail systems need to incorporate these technologies to enable seamless biometric verification, without requiring additional steps or inconvenience for the customer. Privacy concerns also loom large when implementing biometric systems. It is essential to ensure that customer data is protected and used appropriately, in compliance with various international data protection regulations. This is a significant consideration that must be addressed to gain customer trust.

Finally, the cost and infrastructure required for setting up biometric systems can be prohibitive, especially for small and medium-sized businesses. Developing cost-effective solutions is essential to making these technologies accessible and beneficial for a wider range of retailers. Addressing these challenges is crucial to advancing age verification methods in today's modern, digital retail environment.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention provides a comprehensive method for verifying age-restricted purchases using advanced biometric technology and secure digital communications. The process begins with a customer using a communication device to access an application hosted on a remote server, where they create a customer account. A point-of-sale (POS) system at the store is upgraded with an API to facilitate interface with the application database.

Customers provide their biometric information using a biometric scanner, which is processed and combined with barcode/QR Code data to generate a unique value for database transmission. A customer token, generated and verified by a processing device, enables approved customers to authorize age-restricted transactions securely.

In one embodiment, the method of the present invention includes several steps to enhance security and ease of use. Customers log in using a name and password, provide necessary personal information, and upload government-issued identification. Biometric data is then securely stored alongside this information. During a transaction, customers are prompted to provide current biometric data, which is verified against stored data to grant access to age-restricted purchases.

Further steps involve confirming the customer's age (18 or 21 years) using the stored information and processing devices, ensuring compliance with legal restrictions.

The system of the present invention also supports creating and activating customer tokens, submitting requests to a centralized server, and receiving approval tokens to complete transactions. The architecture is designed to allow for efficient handling of flagged tokens to prevent unauthorized purchases, ensuring high security and regulatory compliance in environments requiring strict age verification.

### BRIEF DESCRIPTION OF THE DRAWINGS

FIG. 1 is an illustration of an online platform consistent with various embodiment of the present disclosure.

FIG. 2 is a block diagram of a computing device for implementing the methods disclosed herein, in accordance with some embodiments.

FIG. 3 is an illustration of a flowchart of the present invention.

FIG. 4 is an illustration of a flowchart of the present invention.

FIG. 5 is an illustration of a flowchart of the present invention.

FIG. 6 is an illustration of a flowchart of the present invention.

FIG. 7 is an illustration of a flowchart of the present invention.

FIG. 8 is an illustration of a flowchart of the present invention.

FIG. 9 is an illustration of a flowchart of the present invention.

FIG. 10 is an illustration of a flowchart of the present invention.

FIG. 11 is an illustration of a flowchart of the present invention.

FIG. 12 is an illustration of a flowchart of the present invention.

FIG. 13 is a block diagram of the system of the present invention.

### DETAIL DESCRIPTIONS OF THE INVENTION

All illustrations of the drawings are for the purpose of describing selected versions of the present invention and are not intended to limit the scope of the present invention.

The present invention comprises an advanced application facilitating the creation of unique user accounts via mobile applications or web browsers, thus enabling tech-savvy users to engage in a seamless registration process. The application is designed to be lightweight and cross-platform, allowing installation on various mobile devices for universal accessibility.

The present invention includes a comprehensive user database, systematically structured to store and track user verification and activation statuses. Retail engagement is achieved through a dedicated POS API implemented per retailer, identifying those as active supporters of the application. Additionally, a mobile app tutorial is provided to guide users through the application's features and functionalities effectively.

A significant enhancement includes upgrading retailer POS systems with an API, facilitating seamless interface operations with the application database. The upgraded POS system enables users to opt for the application's automatic age-verification process or revert to conventional age-verification methods as default.

The inventive token handling schema ensures secure identification and status maintenance, allowing necessary interactions to conduct automated age-verification efficiently. Triggers within existing retailer kiosk POS programming activate upon inventory of products requiring age-verification.

The application offers an option prompting users to select its automated age-verification or defaults to retailer's standard processes. An interactive multimedia tutorial elucidates the integration process with retailer POS kiosks. The invention ensures secure token recognition and conversion across multiple network nodes during age-verification, with each node maintaining a unique and untraceable token identifier for privacy.

Tokens, embedded with critical information, including retailer details, kiosk data, and subscription information, contribute to generating a unique 2D barcode/QR code by combining POS kiosk tokens with transaction identifiers. The method to display this unique barcode/QR code on the retailer POS kiosk is thoroughly detailed.

The mobile application encompasses user account management and age-verification capabilities during purchase transactions. It maintains a property to store user accounts, facilitate updates, and validate age-verification, essential for creating user tokens. Furthermore, the application interfaces with native device biometrics to synchronize with age-verification processes.

Capabilities within the mobile application include utilizing native barcode/QR code reading functions during POS age-verification. It converts barcode/QR code images into data, subsequently merging with user information to create a new value ready for database transmission. The invention's secure mechanisms enable the lightweight transmission of this data across the internet to the database.

The database then functions to perform comparison analyses against active user statuses, utilizing confirmation protocols to securely transmit purchase approvals to the POS kiosk. This invention enhances efficiency and security in age-verification processes within various retail environments.

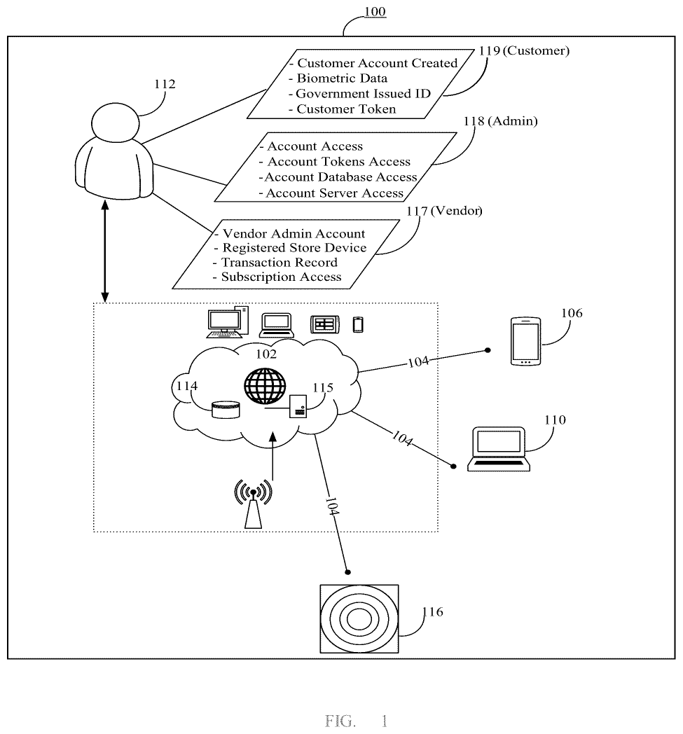

FIG. 1 is an illustration of an online platform 100 consistent with various embodiments of the present disclosure. By way of non-limiting example, the online platform 100 to enable management of customer data may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

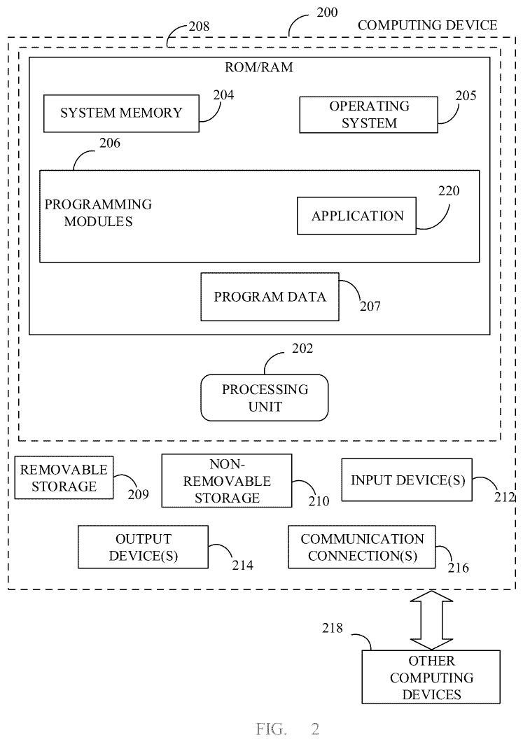

With reference to FIG. 2, a system 1300 consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. In the preferred embodiment the information being stored in the system memory 204 is an application token and information pertaining to a transaction of purchase. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

As can be seen in FIG. 1 through FIG. 13, the preferred embodiment of the present invention is a method for verifying age restricted purchases. The method of the present invention checks the age of the customer to ensure it is above the required age for a purchase. Further, the method of the present invention takes the information of the customer and verifies the information against government identification. The method of the present invention utilizes biometrics within the electronic device of a customer to confirm the identity of a customer at the time of purchase. For example, if a customer wants to buy an item where the customer must be at least 18 years old, the customer will upload a government issued ID to the web application where it is verified. Prior to purchasing the age restricted item, the customer's electronic device will verify biometric information from the customer to ensure it is the proper customer purchasing the item. In this way, the method of the present invention allows stores to verify age restricted purchases electronically without an in-person staff.

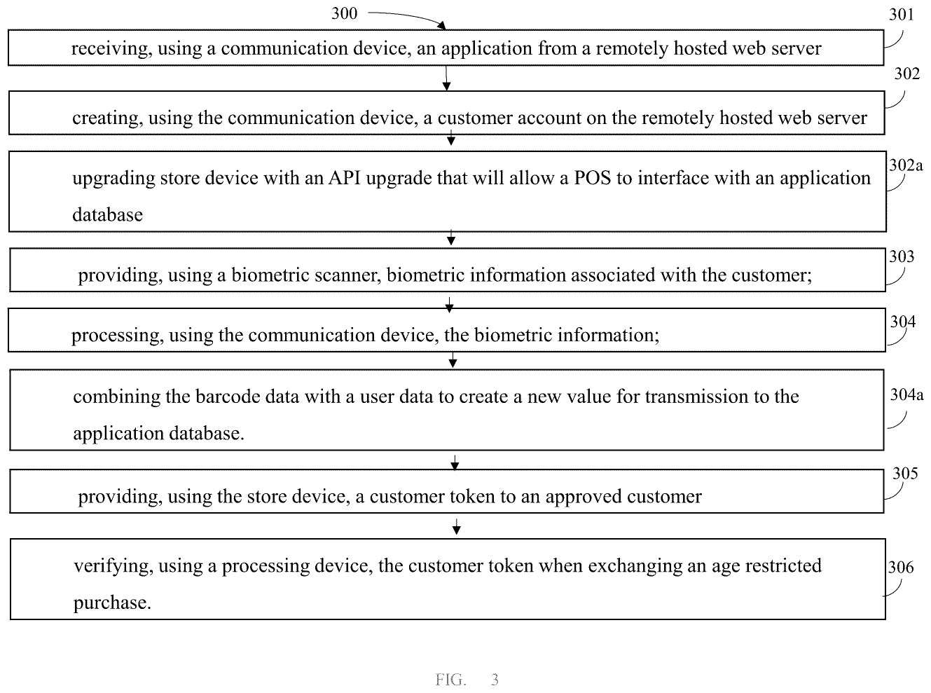

As can be seen in FIG. 3, the system 1300 used to execute the method 300 of the present invention allows the present invention to function to verify an age restricted purchase 1308. To accomplish this, the method of the present invention may include a step 301 of receiving, using a communication device 1301, an application from a remotely hosted web server. The communication device 1301 is an electronic device utilized by a customer such as a cell phone or other mobile electronic device. The remotely hosted web server is a cloud-based server that provides the customer with a cell phone application. The system 1300 used to execute the method 300 of the present invention may include a step 302 of creating, using the communication device 1301, a customer account on the remotely hosted web server. The customer account is an account associated with the customer. In continuation of the previous example the customer can download an application from a mobile phone application store onto their mobile electronic device where the customer can then create an account representing the customer.

POS, or Point of Sales, denotes a distinguished locale wherein a customer consummates the financial transaction for goods or services rendered. It is within this jurisdiction that sales taxes may be deemed due and payable to the appropriate authorities.

API, or Application Programming Interface, signifies an intricate ensemble of definitions and protocols orchestrated for the construction and amalgamation of application software, enabling seamless integration and functionality.

In one embodiment, the present invention may include a step 302a of upgrading store device (POS system) with an API upgrade that will allow a POS to interface with the application database. The retailers POS system API upgrade will allow a user to select the application or to default to the normal age-verification process.

As can be seen in FIG. 3, the system 1300 used to execute the method 300 of the present invention allows the present invention to gather information about the customer. To accomplish this, the method 300 of the present invention may include a step 303 of providing, using a biometric scanner 1305, biometric information associated with the customer. The biometric scanner 1305 is an electronic device that can gather three-dimensional and two-dimensional visual information. The biometric information gathered is visually identifying information associated with the customer such as a fingerprint, facial scan, or iris scan. The system 1300 used to execute the method 300 of the present invention may include a step 304 of processing, using the communication device 1302, the biometric information. In continuation of the previous example the customer uses the biometric scanner 1305 to gather a fingerprint or other identifying visual information that is then connected to the customer profile.

In one embodiment, the present invention may include a step 304a of combining the barcode/QR code data with the user data to create a new value for transmission to the application database. The user data may include customer information that may encompass, but is not limited to, the following data elements: the customer's name, date of birth, email address, phone number, and physical address. Furthermore, the invention may provide a mechanism for the upload of a tangible copy of customer identification, namely: a state-issued driver's license number, a state identification card number, or a government-issued passport number.

In addition, the present invention may incorporate biometric data, encompassing but not limited to, facial scan data, retinal scan data, and fingerprint scan data. These elements serve to fortify the identification verification process integral to the system.

The generation of a new value for transmission to the application database may enable the establishment of a secure, lightweight data transfer across the internet to the database.

The method and system of the present invention may utilize secure light-weight data transmission, wherein an efficient encryption protocol ensures data privacy and integrity, coupled with light-weight authentication for identity verification, while optimizing for low power consumption, minimal latency, efficient bandwidth usage, scalable integration, and maintaining data integrity, thereby addressing the challenges of constrained computational environments such as IoT and mobile networks.

As can be seen in FIG. 3, the system 1300 used to execute the method 300 of the present invention allows the present invention to function as the verification process of the customer's identity and age. To accomplish this, the method 300 of the present invention may include a step 305 of providing, using the store device 1304, a customer token to an approved customer. The customer token is a digital token that marks the associated account as verified for a specific purchase. The system 1300 used to execute the method 300 of the present invention may include a step 306 of verifying, using a processing device 1302, the customer token when exchanging an age restricted purchase 1308. The store device 1304 is a standard point of sale device that can scan barcodes and can receive various electronic and physical payment methods. For example, the customer receives a customer token after the customer profile is verified and approved for a certain age. The transaction token is created by the store device 1304 and submitted with the customer token which then allows the customer to purchase the age restricted item upon approval.

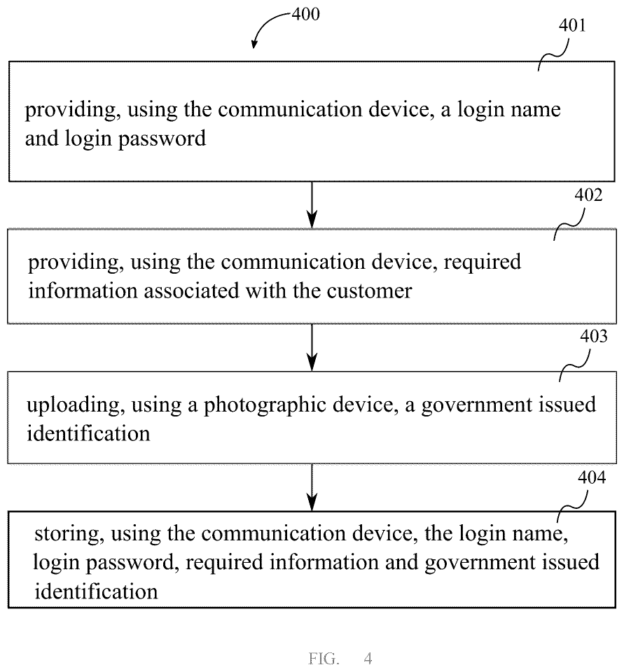

In reference to FIG. 4, a sub-process 400 of the method of the present invention enables the customer to create a customer account and upload required information. To that end, the sub-process 400 begins with a step 401 of providing, using the communication device 1301, a login name and login password. The login name is a series of characters associated with the customer and the login password is a series of characters when used in combination with the login name, unlocks the customer account associated with the customer. The sub-process continues with a step 402 of providing, using the communication device 1301, required information associated with the customer. The required information includes name, date of birth, email address, phone number, and physical address. This required information associated with the customer can be linked to the customer account. The sub-process continues with a step 403 of uploading, using a photographic device 1306, a government issued identification. The photographic device 1306 is a visual camera capable of capturing photos or videos preferably integrated into the electronic device associated with the customer. The government issued identification includes a state issued driver's license, a state identification card, or a government issued passport. The sub-process continues with a step 404 of storing, using a communication device 1301, the login name, login password, required information and government issued identification. The identification information is stored onto the communication device 1301. All the information provided by the customer is saved and stored within the storage device 1309. The customer then requests for a customer token from processing device 1302. Returning to the example, the customer creates a customer account with their own unique login name and login password. The customer then fills out personal information and takes a picture of one of their identification cards, with all the information being submitted for the customer token.

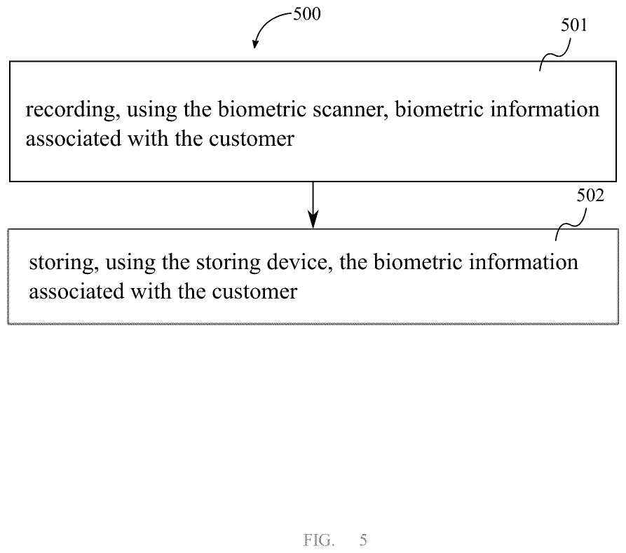

In reference to FIG. 5, a sub-process 500 of the method of the present invention enables biometric information to be linked to the customer. To that end, the sub-process 500 begins with a step 501 of recording, using the biometric scanner 1305, biometric information associated with the customer. The biometric information is gathered with the biometric scanner 1305 that is linked with the customer. The sub-process 500 continues with a step 502 of storing, using the storage device 1309, the biometric information associated with the customer. The biometric information is linked with the associated customer and to their customer account. The biometric information is then stored under this customer's name allowing for the biometric information to be accessed later.

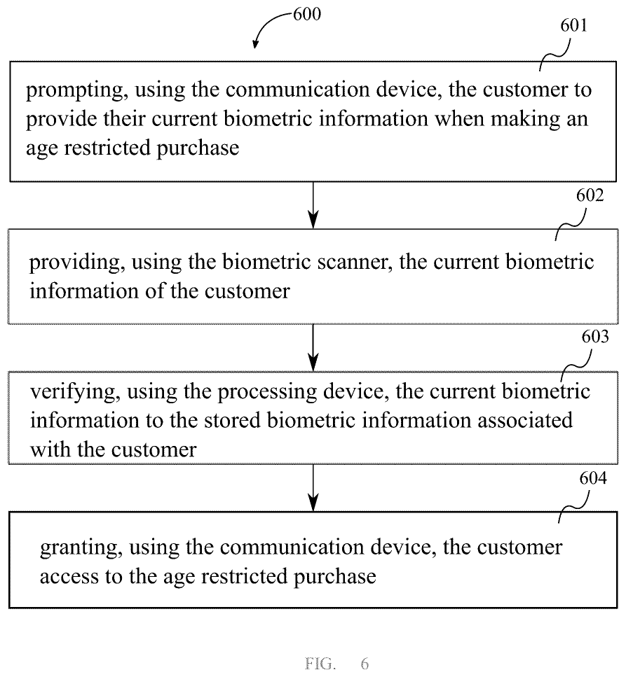

In reference to FIG. 6, a sub-process 600 of the method of the present invention enables the customer to provide and compare current biometric information during the time of a purchase. To that end, the sub-process 600 begins with a step 601 of prompting, using the communication device 1301, the customer to provide their current biometric information when making an age restricted purchase 1308. Through a graphical user interface on the communication device 1301 the customer is asked to either scan their thumbprint, face, eye, or other previously stored biometric information. The sub-process continues with a step 602 of providing, using the biometric scanner 1305, the current biometric information of the customer. The current biometric information is the thumbprint, face, or eye information of the customer at the time of the age restricted purchase 1308. The biometric scanner 1305 rescans the biometric information associated with the customer at the time of purchase. The sub-process continues with a step 603 of verifying, using the communication device 1301, the current biometric information to the stored biometric information associated with the customer. The current biometric information is then compared with the previously stored biometric information of the customer to confirm the identity of the customer making the age restricted purchase 1308. The sub-process continues with a step 604 of granting, using the communication device 1301, the customer access to the age restricted purchase 1308. After the customer's identity is confirmed with the communication device 1301, the customer token is paired with the transaction token and submitted to a centralized server 1307 for approval. Returning to the previous example, at the time of purchase the customer will be asked by their electronic device to scan a biometric feature associated with the customer. After the biometric information is gathered, the biometric information is compared to the stored biometric information, confirming the customer's identity and continuing the transaction.

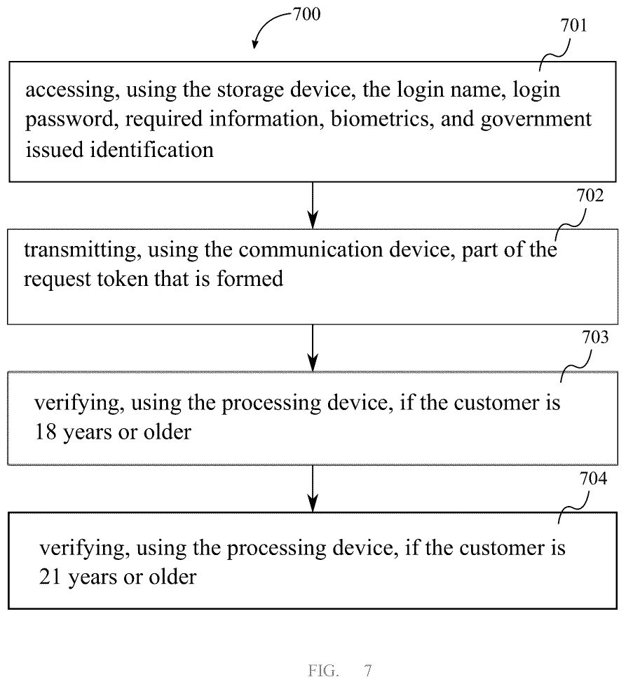

In reference to FIG. 7, a sub-process 700 of the method of the present invention enables the customer to provide information to verify their age. To that end, the sub-process 700 begins with a step 701 of accessing, using the storage device 1309, the login name, login password, required information, government issued identification, and biometric. This constitutes as a customer token. The previously stored information associated with the customer is then retrieved from the storage device 1309. The sub-process continues with a step 702 of transmitting, using the communication device 1301, part of a request token is formed. The sub-process continues with a step 703 of verifying, using the processing device 1302, if the customer is 18 years or older. After utilizing the customer token, the customer is marked if their age is confirmed to 18 or older. The sub-process continues with a step 704 of verifying, using the processing device 1302, if the customer is 21 years or older. After utilizing the customer token and verifying if the customer is 18 years or older, the customer is marked if their age is confirmed to be 21 years or older. Returning to the example, the electronic device associated with the customer sends the customer token in a request token to a remote server where the data is checked with the transaction token. Once the identity of the customer is confirmed with the customer token, the customer is then verified if they are 18 years or older or marked if they are 21 years or older.

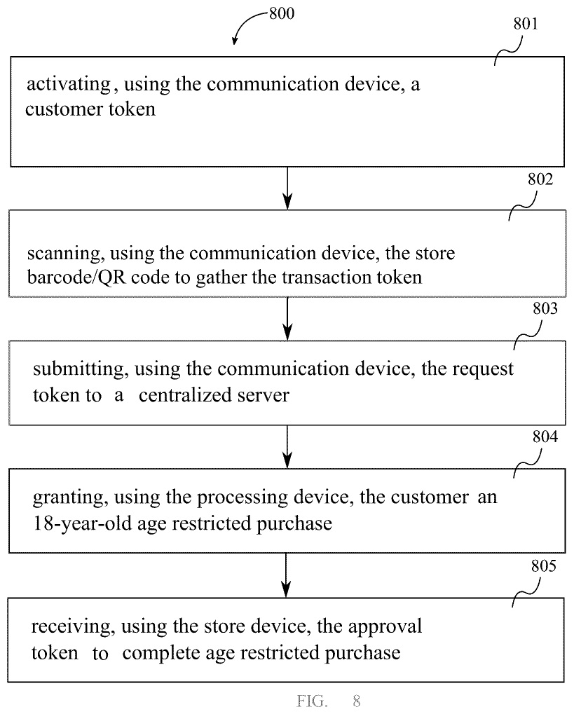

In reference to FIG. 8, a sub-process 800 of the method of the present invention enables the customer to receive a verification if they 18 years or older. To that end, the sub-process 800 begins with a step 801 of activating, using the communication device 1301, a customer token. The customer token is the unique identifier that represents the customer login, government identification, and stored biometric. The sub-process continues with a step 802 of scanning, using the communication device 1301, the store barcode/QR code to gather the transaction token. The transaction token is the unique identifier that represents the product barcode, vendor identification, and store device.

The sub-process continues with a step 803 of submitting, using the communication device 1301, a request token to the centralized server 1307. The sub-process continues with a step 804 of granting, using the processing device 1302, the customer an 18-year-old age restricted purchase 1308. The sub-process continues with a step 805 of receiving, using the store device 1304, the approval token which will complete the age restricted purchase 1308. The store device 1304 then allows the customer to continue with their age restricted purchase 1308 because their approval token is confirmed.

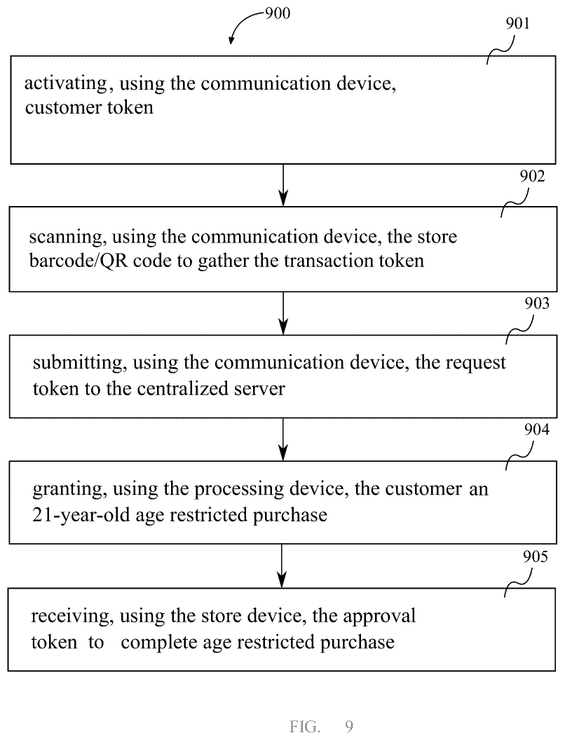

In reference to FIG. 9, a sub-process 900 of the method of the present invention enables the customer to receive a verification if they are 21 years or older. To that end, the sub-process 900 begins with a step 901 of activating, using the communication device 1301, a customer token. The customer token is the unique identifier that represents the customer login, government identification, and stored biometric. The sub-process continues with a step 902 of scanning, using the communication device 1301, the store barcode/QR code to gather the transaction token. The transaction token is the unique identifier that represents the product barcode, vendor identification, and store device. The sub-process continues with a step 903 of submitting, using the communication device 1301, a request token to the centralized server 1307. The sub-process continues with a step 904 of granting, using the processing device 1302, the customer a 21-year-old age restricted purchase 1308. The sub-process continues with a step 905 of receiving, using the store device 1304, the approval token which will complete the age restricted purchase 1308. The store device 1304 then allows the customer to continue with their age restricted purchase 1308 because their approval token is confirmed.

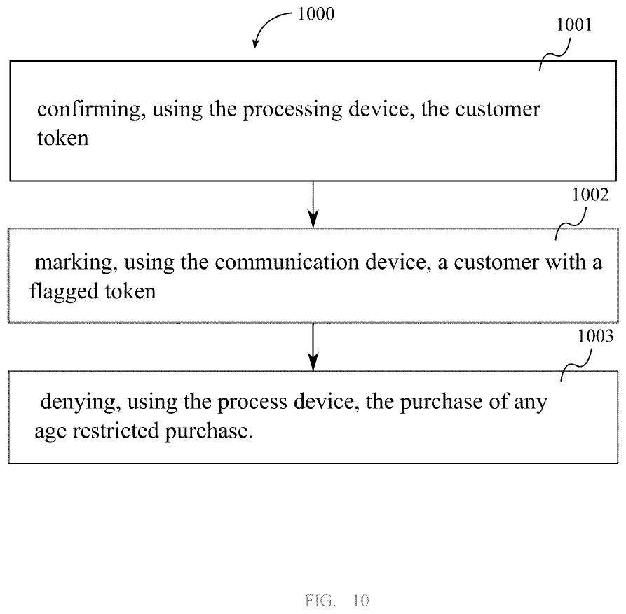

In reference to FIG. 10, a sub-process 1000 of the method of the present invention enables the customer account to be flagged for an incorrect identity confirmation. To that end, the sub-process 1000 begins with a step 1001 of confirming, using the processing device 1302, the customer token. The processing device 1302 is used to analyze and ensure that the customer token can be granted. A customer token is granted pending a customer account has been created successfully, the biometric on the communication device 1301 are activated, and the government identification has been successfully provided. The sub-process 1000 continues with a step 1002 of marking, using the communication device 1301, a customer with a flagged token. The flagged token is a customer whose qualifications are not approved by the processing device 1302. The sub-process 1000 continues with a step 1003 of denying, using the processing device 1302, the purchase of any age restricted purchase 1308. If customer token is not validated for the age restricted product, the age restricted purchase 1308 approval is denied. Returning to the example, when a customer token does not meet the qualifications, that customer account will not allow the customer to complete that particular age restricted purchase 1308.

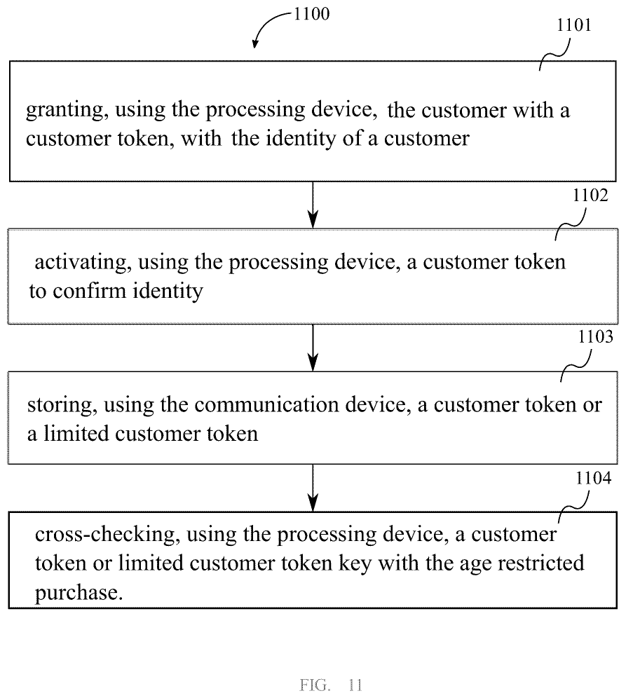

In reference to FIG. 11, a sub-process 1100 of the method of the present invention enables customers with confirmed identities to obtain various digital tokens to complete transactions. To that end, the sub-process 1100 begins with a step 1101 of granting, using the processing device 1302, the customer with a customer token, with the identity of the customer. The sub-process 1100 continues with a step 1102 of activating, using the processing device 1302, a customer token to confirm identity. The confirmed identity is a customer identity that has been approved with the customer account, government issued identification, and biometric information. The sub-process 1100 continues with a step 1103 of storing, using the communication device 1301, a customer token, or a limited customer token. Depending on the age of the customer, customer token or limited customer token is stored to the communication device 1301. The sub-process 1100 continues with a step 1104 of cross-checking, using the processing device 1302, a customer token or limited customer token with the age restricted purchase 1308. Depending on the age restriction of the purchase, the processing device 1302 ensures the customer obtains the proper type of customer token before completing the transaction. Returning to the previous example, if the customer is attempting to make an age restricted purchase 1308, and the customer's identity is confirmed, a customer token is provided if the customer is 21 years or older. If the customer is attempting to make an age restricted purchase 1308, and the customer's identity is confirmed, a limited customer token is provided if the customer is 18 years or older but younger than 21 years. The electronic device associated with the customer then ensures the type of customer token obtained by the customer is applicable to the age restriction of the purchase.

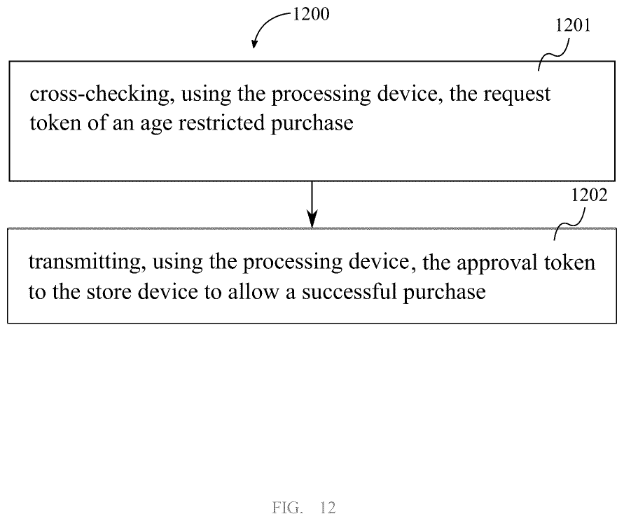

In reference to FIG. 12, a sub-process 1200 of the method of the present invention enables a confirmation to be sent to the store device 1304 after a successful approval. To that end, the sub-process 1200 begins with a step 1201 of cross-checking, using the processing device 1302, the request token of age restricted purchase 1308. The processing device 1302 confirms that the customer meets the proper age and identification for the age requirement for the purchase. The sub-process 1200 continues with a step 1202 of transmitting, using the processing device 1302, the approval token, to the store device to allow a successful purchase. The confirmation email contains the information about the age-restricted purchase, and a completed verification check of the identity of the customer.

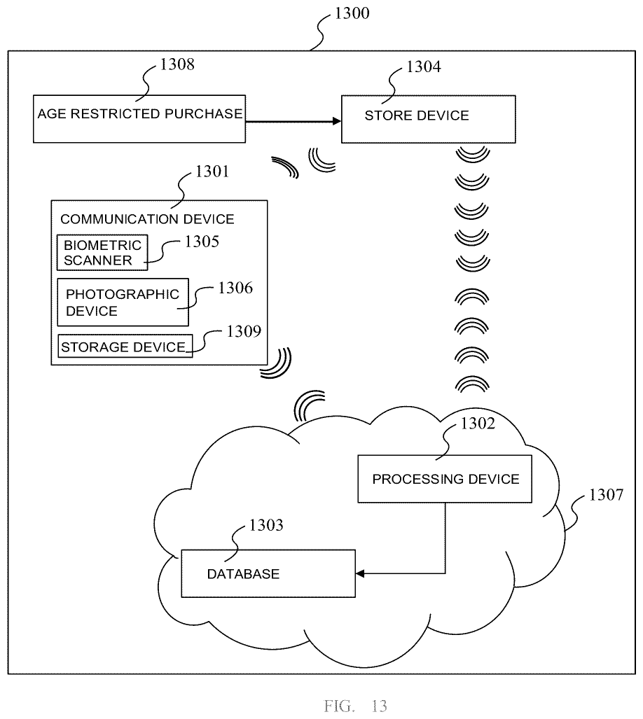

FIG. 13, illustrates a block diagram of a system 1300 for verifying age restricted purchases, in accordance with some embodiments. Accordingly, the system 1300 may include a communication device 1301. Further the communication device 1301 may be configured for receiving an application from a remotely hosted web server. Further, the communication device 1301 may be configured for creating a customer account on the remotely hosted web server. Further, the communication device 1301 may be configured for providing a customer token to an approved customer. Further, the system 1300 may include the centralized server 1307 communicatively coupled with the communication device 1301. Further, the system 1300 must have a communication device 1301, with native biometric scanning capabilities. Further, the biometric scanner 1305 may be configured for providing biometric information associated with the customer. Further, the system 1300 may include a store device 1304 that remotely communicates with the communication device 1301. Further, the store device 1304 may be configured for receiving the approval token from the centralized server 1307.

Furthermore, in some embodiments the communication device 1301 may be further configured for providing a login name and login password. Further the communication device 1301 may be further configured for providing required information associated with the customer. Further the communication device 1301 may be further configured for prompting the customer to provide their current biometric information when making an age restricted purchase 1308. Further the store device 1304 may be further configured for granting the customer access to the age restricted purchase 1308. Further, the system 1300 may include a photographic device 1306 communicatively coupled with the communication device 1301. The photographic device 1306 may be configured for uploading a government issued identification. Further, the system 1300 may include a database 1303 communicatively coupled with the processing device 1302. The database 1303 may be configured for storing the login name, login password, customer token, request token, and approval token. The biometric scanner 1305 further configured for recording biometric information associated with the customer. Further, the biometric scanner 1305 may be configured for providing the current biometric information of the customer. Further, the processing device 1302 may be configured for verifying customer token, request token, and approval token with the customer and the age restricted product.

Furthermore, in some embodiments the communication device 1301 may be further configured for storing the login name, login password, required information and government issued identification. Further, the processing device 1302 may be configured for granting the customer 18-year-old age restricted purchases 1308. Further, the processing device 1302 may be configured for granting the customer 21-year-old age restricted purchases 1308. The store device 1304 may be further configured for presenting the transaction token. The database 1303 may be further configured for storing the request token and approval token. The processing device 1302 may be further configured for verifying if the customer is 18 years or older. Further, the processing device 1302 may be configured for verifying if the customer is 21 years or older. Further, the processing device 1302 may be configured for generating a limited approval token. Further, the processing device 1302 may be configured for generating an approval token.

Furthermore, in some embodiments the processing device 1302 may be further configured for marking a customer with a flagged identity. Further, the processing device 1302 may be configured for marking a customer with an approved identity. Further, the processing device 1302 may be configured for providing an approval token or a limited approval token. Further, the centralized server 1307 may be configured for transmitting a confirmation email to the customer after a successful purchase. The processing device 1302 may be further configured for denying the purchase of any age restricted purchase 1308. The processing device 1302 may be further configured for confirming the customer token. Further, the processing device 1302 may be configured for cross-checking an approval token or limited approval token with the age restricted purchase 1308.

Although the invention has been explained in relation to its preferred embodiment, it is to be understood that many other possible modifications and variations can be made without departing from the spirit and scope of the invention as hereinafter claimed.

What is claimed is:

1. A method for verifying age restricted purchases comprising the steps of:
receiving, using a communication device, an application from a remotely hosted web server;
creating, using the communication device, a customer account on the remotely hosted web server;
upgrading a store device with an API upgrade that will allow a POS to interface with an application database;
providing, using a biometric scanner, biometric information associated with the customer;
processing, using the communication device, the biometric information;
combining the barcode/QR code data with a user data to create a new value for transmission to the application database,
providing, using the store device, a customer token to an approved customer; and
verifying, using a processing device, the customer token when exchanging an age restricted purchase.

2. The method for verifying age restricted purchases as claimed in claim 1 comprising:
providing, using the communication device, a login name and login password;
providing, using the communication device, required information associated with the customer;
uploading, using a photographic device, a government issued identification; and
storing, using the communication device, the login name, login password, required information and government issued identification.

3. The method for verifying age restricted purchases as claimed in claim 2 comprising:
recording, using the biometric scanner, biometric information associated with the customer; and
storing, using the storing device, the biometric information associated with the customer.

4. The method for verifying age restricted purchases as claimed in claim 3 comprising:
prompting, using the communication device, the customer to provide their current biometric information when making an age restricted purchase;
providing, using the biometric scanner, the current biometric information of the customer;
verifying, using the communication device, the current biometric information to the stored biometric information associated with the customer; and
granting, using the communication device, the customer access to the age restricted purchase.

5. The method for verifying age restricted purchases as claimed in claim 2 comprising:
accessing, using the storage device, the login name, login password, required information, biometrics, and government issued identification;
transmitting, using the communication device, part of the request token that is formed;
verifying, using the processing device, if the customer is 18 years or older; and
verifying, using the processing device, if the customer is 21 years or older.

6. The method for verifying age restricted purchases as claimed in claim 5 comprising:
activating, using the communication device, a customer token;
scanning, using the communication device, the store barcode/QR code to gather the transaction token;
submitting, using the communication device, the request token to a centralized server;
granting, using the processing device, the customer an 18-year-old age restricted purchase; and
receiving, using the store device, the approval token which will complete the age restricted purchase.

7. The method for verifying age restricted purchases as claimed in claim 5 comprising:
activating, using the communication device, the customer token;
scanning, using the communication device, the store barcode/QR code to gather the transaction token;
submitting, using the communication device, the request token to the centralized server;
granting, using the processing device, the customer a 21-year-old age restricted purchase; and
receiving, using the store device, the approval token which will complete the age restricted purchase.

8. The method for verifying age restricted purchases as claimed in claim 3 comprising:
confirming, using the processing device, the customer token;
marking, using the communication device, a customer with a flagged token; and
denying, using the process device, the purchase of any age restricted purchase.

9. The method for verifying age restricted purchases as claimed in claim 3 comprising:
granting, using the processing device, the customer with a customer token, with the identity of the customer;
activating, using the processing device, a customer token to confirm identity;
storing, using the communication device, a customer token or a limited customer token; and
cross-checking, using the processing device, a customer token or limited customer token with the age restricted purchase.

10. The method for verifying age restricted purchases as claimed in claim 9 comprising:
cross-checking, using the processing device, the request token of an age restricted purchase; and
transmitting, using the processing device, the approval token to the store device to allow a successful purchase.

11. A method for verifying age restricted purchases comprising the steps of:
receiving, using a communication device, an application from a remotely hosted web server;
creating, using the communication device, a customer account on the remotely hosted web server;
upgrading a store device with an API upgrade that will allow a POS to interface with an application database;
providing, using a biometric scanner, biometric information associated with the customer;
processing, using the communication device, the biometric information;
combining the barcode/QR code data with user data to create a new value for transmission to the application database;
providing, using the store device, a customer token to an approved customer;
verifying, using a processing device, the customer token when exchanging an age restricted purchase;
providing, using the communication device, a login name and login password;
providing, using the communication device, required information associated with the customer;
uploading, using a photographic device, a government issued identification; and
storing, using the communication device, the login name, login password, required information and government issued identification.

12. The method for verifying age restricted purchases as claimed in claim 11 comprising:
recording, using the biometric scanner, biometric information associated with the customer;
storing, using the storing device, the biometric information associated with the customer;
prompting, using the communication device, the customer to provide their current biometric information when making an age restricted purchase;
providing, using the biometric scanner, the current biometric information of the customer;
verifying, using the processing device, the current biometric information to the stored biometric information associated with the customer; and
granting, using the communication device, the customer access to the age restricted purchase.

13. The method for verifying age restricted purchases as claimed in claim 11 comprising:
accessing, using the storage device, the login name, login password, required information, biometrics, and government issued identification;
transmitting, using the communication device, part of the request token that is formed;
verifying, using the processing device, if the customer is 18 years or older; and
verifying, using the processing device, if the customer is 21 years or older.

14. The method for verifying age restricted purchases as claimed in claim 13 comprising:
activating, using the communication device, a customer token;
scanning, using the communication device, the store barcode/QR code to gather the transaction token;
submitting, using the communication device, the request token to a centralized server;
granting, using the processing device, the customer an 18-year-old age restricted purchase; and
receiving, using the store device, the approval token to complete an age restricted purchase.

15. The method for verifying age restricted purchases as claimed in claim 13 comprising:
activating, using the communication device, the customer token;
scanning, using the communication device, the store barcode/QR code to gather the transaction token;
submitting, using the communication device, the request token to the centralized server;
granting, using the processing device, the customer a 21-year-old age restricted purchase; and
receiving, using the store device, the approval token to complete age restricted purchase.

16. The method for verifying age restricted purchases as claimed in claim 12 comprising:
confirming, using the processing device, the customer token;
marking, using the communication device, a customer with a flagged token;
denying, using the process device, the purchase of any age restricted purchase;
granting, using the processing device, the customer with a customer token, with the identity of the customer;
activating, using the processing device, a customer token to confirm identity;
storing, using the communication device, a customer token, or a limited customer token; and
cross-checking, using the processing device, a customer token or limited customer token with the age restricted purchase.

17. The method for verifying age restricted purchases as claimed in claim 16 comprising:
cross-checking, using the processing device, the request token of an age restricted purchase; and
transmitting, using the processing device, the approval token to the store device to allow a successful purchase.

18. A system for verifying age restricted purchases, the system comprising:
a communication device configured for:
receiving an application from a remotely hosted web server;
creating a customer account on the remotely hosted web server;
upgrading a store device with an API upgrade that will allow the store device to interface with an application database;
a processing device configured for:
processing the biometric information;
verifying the customer token when exchanging an age restricted purchase;
combining the barcode/QR code data with a user data to create a new value for transmission to the application database;
a biometric scanner configured for:
providing biometric information associated with the customer; and
the store device configured for:
providing a customer token to an approved customer.

19. The system for verifying age restricted purchases as claimed in claim 18 wherein the system comprising:
the communication device further configured for:
providing a login name and login password;
providing required information associated with the customer;
storing the login name, login password, required information and government issued identification;
prompting the customer to provide their current biometric information when making an age restricted purchase;
granting the customer access to the age restricted purchase;
transmitting part of the request token that is formed;
the processing device further configured for:
verifying the current biometric information to the stored biometric information associated with the customer;
verifying if the customer is 18 years or older;
verifying if the customer is 21 years or older;
a photographic device configured for:
uploading a government issued identification;
the storage device further configured for:
storing the biometric information associated with the customer;
accessing the login name, login password, required information, biometrics, and government issued identification;
the biometric scanner further configured for:
recording biometric information associated with the customer; and
providing the current biometric information of the customer.

20. The system for verifying age restricted purchases as claimed in claim 18 wherein the system comprising:
The communication device further configured for:
activating a customer token;
scanning the store barcode/QR code to gather the transaction token;
submitting the request token to a centralized server;
activating the customer token;
scanning the store barcode/QR code to gather the transaction token;
submitting the request token to the centralized server;
marking a customer with a flagged token;
storing a customer token or a limited customer token;
the store device further configured for:
receiving the approval token to complete an age restricted purchase;
receiving the approval token to complete age restricted purchase;
the processing device further configured for:
granting the customer, an 18-year-old age restricted purchase;
granting the customer, a 21-year-old age restricted purchase;
confirming the customer token;
denying the purchase of any age restricted purchase;
granting the customer with a customer token, with the identity of the customer;
activating a customer token to confirm identity;
cross-checking a customer token or limited customer token with the age restricted purchase;
cross-checking the request token of an age restricted purchase; and
transmitting the approval token to the store device to allow a successful purchase.
